(19) United States
(12) Patent Application Publication
(10) Pub. No.: US 2025/0192581 A1
(43) Pub. Date: Jun. 12, 2025

(54) CHARGING CONTROL CIRCUIT, CHARGER, AND CHARGING METHOD

(71) Applicant: Anker Innovations Technology Co., Ltd., Changsha (CN)

(72) Inventor: Enshan Li, Shenzhen (CN)

(21) Appl. No.: 19/038,414

(22) Filed: Jan. 27, 2025

Related U.S. Application Data
(63) Continuation of application No. PCT/CN2023/109566, filed on Jul. 27, 2023.

(30) Foreign Application Priority Data
Jul. 28, 2022 (CN) 202210899875.4

(51) Int. Cl. H02J 7/00; H02J 7/04

(52) U.S. Cl. CPC H02J 7/00309; H02J 7/0042; H02J 7/04

(57) ABSTRACT

The present application provides a charging control circuit, a charger, and a charging method. The charging control circuit includes a cell module, a first transformer module, a second transformer module, a port module, and a first control module. The first transformer module is spaced apart from the cell module. The second transformer module is disposed between the first transformer module and the cell module. The port module is connected to an output terminal of the first transformer module, an output terminal of the second transformer module, and the cell module, respectively. The first control module is connected to the first transformer module, the second transformer module, and the port module. The first control module is configured to control an on or an off of the first transformer module and the second transformer module.

### CROSS REFERENCE TO RELATED APPLICATION

This application is a Continuation of International Patent Application No. PCT/CN2023/109566, filed on Jul. 27, 2023. The International Patent Application No. PCT/CN2023/109566 claims priority to Chinese Patent Application No. 202210899875.4, entitled “CHARGING CONTROL CIRCUIT, CHARGER, AND CHARGING METHOD”, filed on Jul. 28, 2022. The foregoing applications are incorporated herein by reference in their entirety.

### TECHNICAL FIELD

The present application relates to the field of electronic product chargers, in particular, to a charging control circuit, a charger, and a charging method.

### BACKGROUND

An integrated portable power source is a charging device that integrates a charger plug and a portable power source. A transformer and a battery cell of the integrated portable power source are usually integrated into a same shell. In order to ensure the portability of the integrated portable power source, the transformer and the battery cell are usually close, where the heat of the transformer is easily conducted to the battery cell, which affects the safety of the battery cell.

### SUMMARY

The present application provides a charging control circuit, a charger, and a charging method, which can solve the problem that a temperature of a battery cell is prone to rise in an integrated portable power source.

In a first aspect, the present application provides a charging control circuit, including a cell module, a first transformer module, a second transformer module, a port module, and a first control module. The first transformer module is spaced apart from the cell module. The second transformer module is disposed between the first transformer module and the cell module. The port module is connected to an output terminal of the first transformer module, an output terminal of the second transformer module, and the cell module, respectively. The first control module is connected to the first transformer module, the second transformer module, and the port module. The first control module is configured to adjust output power values of the first transformer module and the second transformer module according to a first desired power value of an external load, so that the output power values correspond to the first desired power value.

Based on the charging control circuit in the above examples of the present application, because the first transformer module is farther from the cell module than the second transformer module, the two power modules have a larger surface area than a single power module under the same power, which can effectively increase the heat dissipation area, improve heat dissipation efficiency, and thus minimize the temperature of the cell module.

In a second aspect, the present application provides a charger, including: the charging control circuit as described in the above examples and a shell. The shell has a first chamber, a second chamber, and a third chamber sequentially adjacent to each other. The first transformer module, the second transformer module, and the cell module are sequentially disposed in the first chamber, the second chamber, and the third chamber.

Based on the charger in the above examples of the present application, the first chamber, the second chamber, and the third chamber sequentially adjacent to each other separate the first transformer module, the second transformer module, and the cell module, which can not only achieve physical isolation between the first transformer module, the second transformer module, and the cell module, but also can ensure a compact structure of the charger.

In a third aspect, the present application provides a charging method applied to the charging control circuit as described in the above examples, the charging method including the following steps:

When the first control module detects that only one port is connected to an external load, the first control module obtains the first desired power value of the external load.

If the first desired power value is less than or equal to a maximum output power value of the first transformer module, the first control module controls the first transformer module to output the output power value equal to the first desired power value, and controls the second transformer module to turn off.

If the first desired power value is greater than the maximum output power value of the first transformer module, the first control module controls the second switch to close, so that the first transformer module and the second transformer module output the output power values to the external load in parallel. When the first desired power value is less than or equal to a maximum total output power value of the first transformer module and the second transformer module, the output power value is equal to the first desired power value. When the first desired power value is greater than the maximum total output power value of the first transformer module and the second transformer module, the output power value is equal to the maximum total output power value.

Based on the charging method in the above examples of the present application, the first transformer module is preferentially used, followed by the second transformer module, making it difficult to conduct the heat generated by the first transformer module during operation to the cell module, slowing down the temperature rise within the cell module, and making the charging control circuit less likely to decrease the power of the first transformer module and the second transformer module due to the temperature protection of the cell module, thereby improving the charging efficiency of the charging control circuit.

In a fourth aspect, the present application provides a charging method applied to the charging control circuit as described in the above examples, the charging method including the following steps:

When the first control module detects that both the first port and the second port are connected to external loads, the first control module obtains the first desired power values of the external loads, where the first desired power values include a desired power value of the external load on the first port and a desired power value of the external load on the second port, and the output power values include the output power value of the first transformer module and the output power value of the second transformer module.

The first control module controls the second switch to open, so that the first transformer module and the second transformer module independently output the output power values to the external load on the first port and the external load on the second port.

If the desired power value of the external load on the first port is less than or equal to the maximum output power value of the first transformer module, the first control module controls the output power value of the first transformer module to be the desired power value of the external load on the first port.

If the desired power value of the external load on the first port is greater than the maximum output power value of the first transformer module, the first control module controls the output power value of the first transformer module to be the maximum output power value of the first transformer module.

If the desired power value of the external load on the second port is less than or equal to the maximum output power value of the second transformer module, the first control module controls the output power value of the second transformer module to be the desired power value of the external load on the second port.

If the desired power value of the external load on the second port is greater than the maximum output power value of the second transformer module, the first control module controls the output power value of the second transformer module to be the maximum output power value of the second transformer module.

Based on the charging method described in the above examples of the present application, the first transformer module and the second transformer module operate independently, so that the first transformer module supplies power to the external load on the first port, and the second transformer module supplies power to the external load on the second port, thereby avoiding voltage drop due to the fact that the external load on the first port and the external load on the second port withstand different maximum voltages, and then avoiding reduction in charging efficiency.

In a fifth aspect, the present application provides a charging method applied to the charging control circuit as described in the above examples, the charging method including the following steps:

When the first control module detects that the first port, the second port, and the third port are all connected to external loads, the first control module obtains the first desired power values of the external loads, where the first desired power values include a desired power value of the external load on the first port, a desired power value of the external load on the second port, and a desired power value of the external load on the third port. The output power values include the output power value of the first transformer module and the output power value of the second transformer module.

The first control module controls the second switch to open, so that the first transformer module independently outputs power to the external load on the first port, and the second transformer module independently outputs power to the external load on the second port and the external load on the third port.

If the desired power value of the external load on the first port is less than or equal to the maximum output power value of the first transformer module, the first control module controls the output power value of the first transformer module to be the desired power value of the external load on the first port.

If the desired power value of the external load on the first port is greater than the maximum output power value of the first transformer module, the first control module controls the output power value of the first transformer module to be the maximum output power value of the first transformer module.

If a sum of the desired power value of the external load on the second port and the desired power value of the external load on the third port is less than or equal to the maximum output power value of the second transformer module, the first control module controls the output power value of the second transformer module to be the desired power value of the external load on the second port.

If the sum of the desired power value of the external load on the second port and the desired power value of the external load on the third port is greater than the maximum output power value of the second transformer module, the first control module controls the output power value of the second transformer module to be the maximum output power value of the second transformer module.

Based on the charging method described in the above examples of the present application, the first transformer module and the second transformer module operate independently, so that the first transformer module supplies power to the external load on the first port, and the second transformer module supplies power to the external load on the second port and the external load on the third port, thereby avoiding voltage drop due to the fact that the external load on the first port and the external loads on the second port and the third port withstand different maximum voltages, and then avoiding reduction in charging efficiency.

### BRIEF DESCRIPTION OF THE DRAWINGS

In order to describe the technical solutions in the examples of the present application, the following briefly introduces the accompanying drawings used for the description of the examples. The accompanying drawings in the following description show only some examples of the present application, and those of ordinary skill in the art can further derive other drawings from the accompanying drawings without any creative effort.

FIG. 1 is a schematic structural diagram of a charging control circuit in one example of the present application;

FIG. 2 is a schematic block diagram of a charging control circuit in one example of the present application;

FIG. 3 is a schematic block diagram of a charging control circuit in another example of the present application;

FIG. 4 is a schematic block diagram of a charging control circuit in still another example of the present application;

FIG. 5 is a schematic block diagram of a charging control circuit in still another example of the present application;

FIG. 6 is a schematic block diagram of a charging control circuit in yet another example of the present application;

FIG. 7 is an exploded structural diagram of a charger in one example of the present application;

FIG. 8 is a flowchart of a charging method in one example of the present application;

FIG. 9 is a flowchart of a charging method in another example of the present application;

FIG. 10 is a flowchart of a charging method in still another example of the present application;

FIG. 11 is a flowchart of a charging method in still another example of the present application; and

FIG. 12 is a flowchart of a charging method in yet another example of the present application.

Explanation of reference numerals: 100. Charging control circuit; 110. Cell module; 120. First transformer module; 130. Second transformer module; 140. Port module; 141. First port; 142. First switch; 143. Second switch; 144. Second port; 145. Third switch; 146. Third port; 147. Fourth switch; 150. First control module; 160. Temperature detection module; 170. Second control module; 200. Charger; 210. Shell; 210a. First chamber; 210b. Second chamber; 210c. Third chamber.

### DETAILED DESCRIPTION

The following further describes the present application in detail in conjunction with the accompanying drawings and examples. It should be understood that the examples described herein are merely used for explaining the present application, but are not used for limiting the present application.

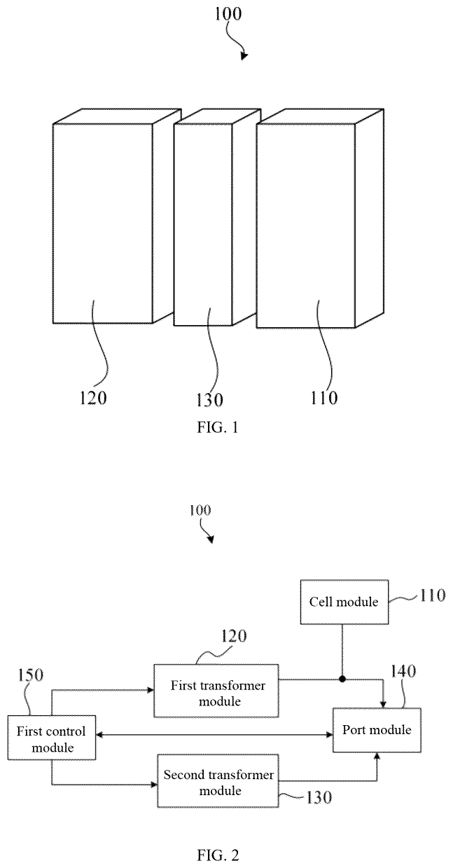

As shown in FIGS. 1 and 2, a first aspect of the present application provides a charging control circuit 100. The charging control circuit 100 includes a cell module 110, a first transformer module 120, a second transformer module 130, a port module 140, and a first control module 150.

The cell module 110 is configured to store power, and the cell module 110 may be one or more lithium batteries. When the charging control circuit 100 is not connected to a mains supply, the cell module 110 may supply power to an external load through the port module 140. It should be noted that the external load may charge the cell module 110 reversely through the port module 140. For example, when the external load is a mobile phone or the like, the cell module 110 charges the mobile phone through the port module 140; when the external load is a charger plug, the charger plug charges the cell module 110 through the port module 140.

The first transformer module 120 is configured to transform mains voltage into voltage required by the load, and the first transformer module 120 includes a first transformer and a first transformer controller. The first transformer is connected to the mains supply, and the first transformer is connected to the port module 140 and the cell module 110. The first transformer controller is connected to the first control module 150 and the first transformer. The first transformer controller adjusts output voltage of the first transformer by changing the duty cycle of a primary coil of the first transformer. For example, the input voltage of the first transformer may be 110 V to 220 V, and the output voltage of the first transformer may be 5 V, 9 V, 15 V, 20 V, etc.

The second transformer module 130 is also configured to transform the mains voltage into the voltage required by the load, and the second transformer module 130 includes a second transformer and a second transformer controller. The second transformer is connected to the mains supply, and the second transformer is connected to the port module 140 and the cell module 110. The second transformer controller is connected to the first control module 150 and the second transformer. The second transformer controller adjusts output voltage of the second transformer by changing the duty cycle of a primary coil of the second transformer. For example, the input voltage of the second transformer may be 110 V to 220 V, and the output voltage of the second transformer may be 5 V, 9 V, 15 V, 20 V, etc. The first transformer module 120 and the second transformer module 130 can supply power to the external load such as a mobile phone through the port module 140 when connected to the mains supply.

The port module 140 is connected to the external load, and the port module 140 is connected to the first transformer module 120, the second transformer module 130, and the cell module 110 respectively, so that the first transformer module 120, the second transformer module 130, or the cell module 110 can discharge externally through the port module 140, or charge the cell module 110 through the port module 140. The port module 140 may include one port or more ports, for example, the port module 140 may be one or more of universal serial bus (USB)-A or USB-C. The first control module 150 is configured to control, according to requested power of the external load on the port module 140, the on or off of the first transformer module 120 and the on or off of the second transformer module 130, to output charging power corresponding to the requested power of the external load.

The first control module 150 is connected to the first transformer module 120, the second transformer module 130, and the port module 140 respectively. The first control module 150 can control, according to a preset program, the on or off of the first transformer module 120 and the second transformer module 130.

Compared to a single large power module, the charging control circuit 100 of the present application has two power modules, namely, the first transformer module 120 and the second transformer module 130. Under the same power, the two power modules have a larger surface area than the single power module, which can effectively increase the heat dissipation area, improve heat dissipation efficiency, and thus minimize the temperature of the cell module 110.

Moreover, in some operating conditions, the first transformer module 120 may be preferentially used to output power. The first transformer module 120 is spaced apart from a battery cell, and the first transformer module 120 is farther from the cell module 110 than the second transformer module 130, so it is relatively difficult to conduct the heat generated by the first transformer module 120 to the cell module 110, which is conducive to reducing the temperature of the cell module 110. For example, after the port module 140 is connected to the external load, the external load communicates with the first control module 150 through the port module 140 to negotiate required power supply, then the first control module 150 controls the first transformer module 120 to preferentially supply power to the external load until the first transformer module 120 reaches its maximum power but still cannot satisfy the power required by the external load, and the first control module 150 controls the second transformer module 130 to start, so that the second transformer module 130 and the first transformer module 120 simultaneously supply power to the external load. When the power supply required by the external load decreases, the power of the second transformer module 130 is preferentially reduced until the second transformer module 130 is turned off, and then the power of the first transformer module 120 is reduced.

In addition, the charging control circuit 100 is an integrated portable power source. After the temperature of the battery cell in the integrated portable power source reaches a protection threshold, the temperature of the battery cell is usually lowered by decreasing the output power, but this method may prolong the charging time. The charging control circuit 100 of the present application has relatively good heat dissipation and the heat of the first transformer module 120 is not easily conducted to the battery cell, so the charging control circuit 100 in the examples of the present application can minimize the time for decreasing power, thereby shortening the charging time.

To sum up, the charging control circuit 100 in the examples of the present application includes a first transformer module 120 and a second transformer module 130, and the first transformer module 120 is farther from the cell module 110 than the second transformer module 130, so the charging control circuit 100 can preferentially use the first transformer module 120 and then use the second transformer module 130 during operation, making it difficult to conduct the heat generated by the first transformer module 120 during operation to the cell module 110, slowing down the temperature rise of the cell module 110, and making the charging control circuit 100 less likely to decrease the power of the first transformer module 120 and the second transformer module 130 due to the temperature protection of the cell module 110, thereby improving the charging efficiency of the charging control circuit 100. Secondly, the present application splits a single large power module into a small first transformer module 120 and a small second transformer module 130, and the thicknesses of both the first transformer module 120 and the second transformer module 130 are less than that of the single larger power module, thereby reducing the thickness of the charging control circuit 100, making a charger 200 with the charging control circuit 100 thinner, and making the charger 200 have less impact on adjacent jacks when plugged into a socket. In addition, the sum of the costs of the first transformer module 120 and the second transformer module 130 is lower than the cost of the single large power module, thereby reducing the cost of the charging control circuit 100.

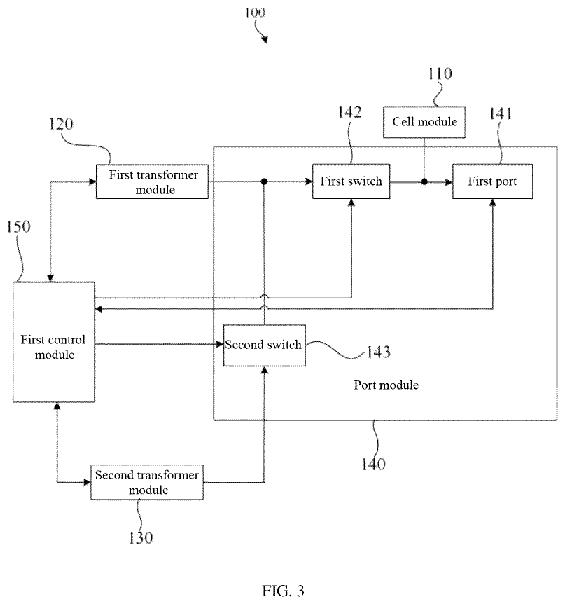

As shown in FIG. 3, in some examples, the port module 140 includes a first sport 141, a first switch 142, and a second switch 143.

The first port 141 is connected to an output terminal of the first transformer module 120, and the first transformer module 120 can supply power to the external load through the first port 141. The first port 141 is connected to the first control module 150, and the first control module 150 can communicate with the external load based on a charging protocol through the first port 141. After the handshake is completed, the first control module 150 can adjust output parameters of the first transformer module 120. The first port 141 may be a USB-C interface or a USB-A interface.

The first switch 142 is connected in series between the output terminal of the first transformer module 120 and the first port 141, and the first switch 142 may be composed of two metal-oxide-semiconductor (MOS) transistors connected in reverse series (back to back) to prevent current from flowing back from the first port 141 to the first transformer module 120. The first switch 142 is connected to the first control module 150, and the first control module 150 can control the switch 142 to close or open, so as to connect or disconnect the first port 141 and the first transformer module 120.

The second switch 143 is connected between the output terminal of the first transformer module 120 and an output terminal of the second transformer module 130, and the second switch 143 may be composed of two MOS transistors connected in reverse series (back to back) to avoid crosstalk between the output current of the first transformer module 120 and the output current of the second transformer module 130. The second switch 143 is connected to the first control module 150, and the first control module 150 can control the second switch 143 to close or open, thereby enabling parallel output or independent output of the first transformer module 120 and the second transformer module 130.

For example, the maximum output power of the first transformer module 120 is 45 W, and the maximum output power of the second transformer module 130 is 20 W. When the power required by the external load is 30 W, the first transformer module 120 can first supply power to the outside, the second switch 143 is open, and the second transformer module 130 is turned off. When the power required by the external load is adjusted to 50 W, the first control module 150 controls the second switch 143 to close, and the first transformer module 120 and the second transformer module 130 simultaneously supply power to the outside, for example, the maximum output power of the first transformer module 120 is 45 W, and the output power of the second transformer module 130 is 10 W, to satisfy the power required by the external load. Generally, the external load has a relatively high-power demand in the early stage of charging and a relatively low power demand in the later stage of charging, but this is not exact. The power required by the external load is related to parameters such as cell capacity and cell temperature, and the required power may change in the charging process. When the external load is charged immediately after high power consumption, the charging power may be limited due to the high cell temperature. After a period of time, the battery cell naturally cools down, and the charging power gradually increases. Notably, when the charging power changes, the voltage may change. Taking fast charging based on a power delivery (PD) protocol as an example, in the charging process, the voltage may be adjusted in four voltage levels: 5 V, 9 V, 15 V, and 20 V. If the first transformer module 120 and the second transformer module 130 charge the external load simultaneously, the voltages of the first transformer module 120 and the second transformer module 130 need to change synchronously.

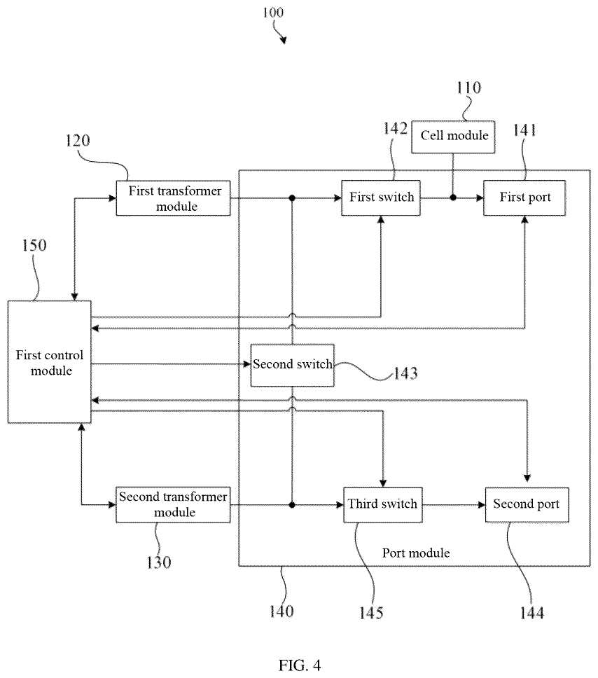

As shown in FIG. 4, in some examples, the port module 140 further includes a second port 144 and a third switch 145.

The second port 144 is connected to the output terminal of the second transformer module 130, and the second transformer module 130 can supply power to the external load through the second port 144. The second port 144 is connected to the first control module 150, and the first control module 150 can communicate with the external load based on the charging protocol through the second port 144. After the handshake is completed, the first control module 150 can adjust output parameters of the second transformer module 130. The second port 144 may be a USB-C interface or a USB-A interface.

The third switch 145 is connected in series between the output terminal of the second transformer module 130 and the second port 144, and the third switch 145 may be composed of two MOS transistors connected in reverse series (back to back) to prevent current from flowing back from the second port 144 to the second transformer module 130. The third switch 145 is connected to the first control module 150, and the first control module 150 can control the third switch 145 to close or open, so as to connect or disconnect the second port 144 and the second transformer module 130.

It can be understood that one power module includes one alternating current to direct current converter (AC/DC converter). Generally, the charger has a plurality of fast charging ports. If a single large power module is connected to the plurality of fast charging ports, according to the above text, each fast charging port supports a different level of voltage, and different external loads often have different voltages in different charging stages, that is, the voltage of different ports at the same time may be the same or different. In order to enable different ports to independently and flexibly adjust the voltage, a direct current to direct current converter (DC/DC converter) is required between the AC/DC converter and each port, and each DC/DC converter controls the voltage of the corresponding port.

This example includes a first transformer module 120 and a second transformer module 130. The first transformer controller can adjust the output voltage of the first transformer by changing the duty cycle of the primary coil of the first transformer. The second transformer controller can adjust the output voltage of the second transformer by changing the duty cycle of the primary coil of the second transformer. That is, in this example, the DC/DC converter is not required between the first transformer module 120 and the first port 141, and between the second transformer module 130 and the second port 144. Therefore, compared to the single large power module, the charging control circuit 100 in the examples of the present application can further save electronic components, thereby further saving costs.

When the external load is connected to only the second port 144, the second transformer module 130 can be preferentially activated. When the output power of the second transformer module 130 is insufficient, the second switch 143 is closed to activate the first transformer module 120, so that the second transformer module 130 and the first transformer module 120 output power together. Alternatively, the second switch 143 is first closed to preferentially activate the first transformer module 120. When the output power of the first transformer module 120 is insufficient, the second transformer module 130 is activated, so that the second transformer module 130 and the first transformer module 120 output power to the external load in parallel.

When the first port 141 and the second port 144 are connected to different external loads, because the charging voltages of the different external loads may be different, the second switch 143 needs to open, and the first transformer module 120 and the second transformer module 130 output power independently.

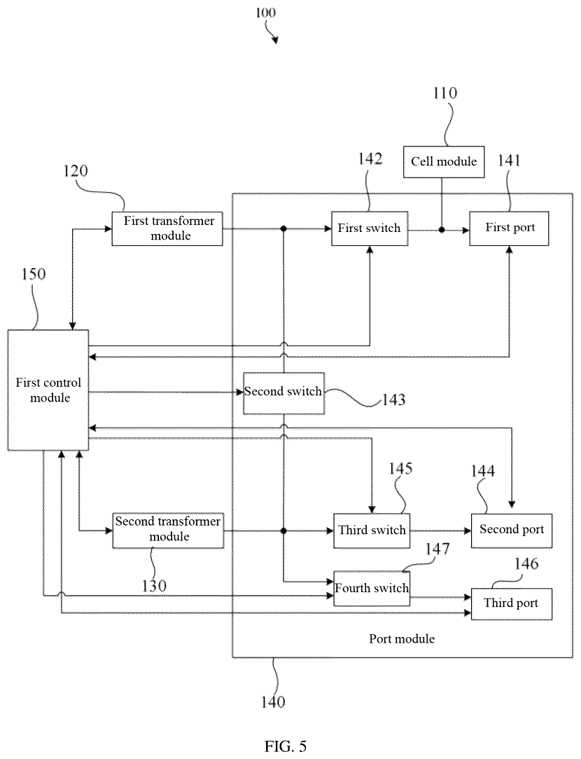

As shown in FIG. 5, in some examples, the port module 140 further includes a third port 146 and a fourth switch 147.

The third port 146 is connected to the output terminal of the second transformer module 130, the second transformer module 130 can supply power to the external load through the third port 146, and the third port 146 is equivalent to parallel to the second port 144. The third port 146 is connected to the first control module 150, and the first control module 150 can communicate with the external load based on the charging protocol through the third port 146. After the handshake is completed, the first control module 150 can adjust the output parameters of the second transformer module 130. The third port 146 may be a USB-C interface or a USB-A interface.

The fourth switch 147 is connected in series between the output terminal of the second transformer module 130 and the third port 146, and the fourth switch 147 may be composed of two MOS transistors connected in reverse series (back to back) to prevent current from flowing back from the third port 146 to the second transformer module 130. The fourth switch 147 is connected to the first control module 150, and the first control module 150 can control the fourth switch 147 to close or open, so as to connect or disconnect the third port 146 and the second transformer module 130.

When the external load is connected to only the third port 146, the second transformer module 130 can be preferentially activated. When the output power of the second transformer module 130 is insufficient, the second switch 143 is closed to activate the first transformer module 120, so that the second transformer module 130 and the first transformer module 120 output power together. Alternatively, the second switch 143 is first closed to preferentially activate the first transformer module 120. When the output power of the first transformer module 120 is insufficient, the second transformer module 130 is activated, so that the second transformer module 130 and the first transformer module 120 output power together.

Notably, when different external loads are connected to the third port 146 and the second port 144 respectively, because the third port 146 is parallel to the second port 144, the voltages of the third port 146 and the second port 144 are the same, based on the lower voltage that the two different external loads can withstand. For example, if the external load on the second port 144 can withstand voltages of 5 V, 9 V, 15 V, and 20 V, and the external load on the third port 146 can withstand a maximum voltage of 5 V, the second transformer module 130 can output only a voltage of 5 V, to prevent the output voltage of the second transformer module 130 from being higher than the maximum voltage that the external load on the third port 146 can withstand, and to avoid damage to the external load on the third port 146.

When the first port 141, the second port 144, and the third port 146 are connected to different external loads respectively, because the charging voltages of the different external loads may be different, the second switch 143 needs to open, the first transformer module 120 and the second transformer module 130 output power independently, and the voltages of the third port 146 and the second port 144 are based on the lower voltage that two different external loads can withstand.

In some examples, the port module 140 further includes a fourth port and a fifth switch. The fourth port is connected to the output terminal of the first transformer module 120, that is, the fourth port is parallel to the first port 141, and the fifth switch is connected in series between the output terminal of the first transformer module 120 and the fourth port. The settings of the fourth port and the fifth switch can refer to the third port 146 and the fourth switch 147 described above. The plurality of ports can be connected to a plurality of external loads, so as to charge the plurality of external loads simultaneously. It can be understood that the port module 140 may include more ports, which are not limited by this example.

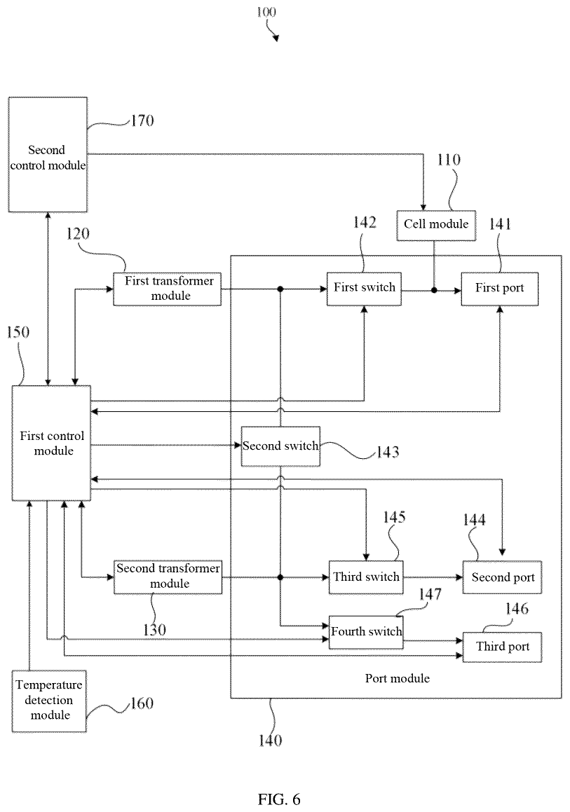

As shown in FIG. 6, in some examples, the charging control circuit 100 further includes a temperature detection module 160, the temperature detection module 160 is disposed on a surface of the side of the cell module 110 facing the second transformer module 130, and the temperature detection module 160 is connected to the first control module 150. When the charging control circuit 100 is connected to the mains supply, the main reason why the temperature of the cell module 110 rises is the conduction of heat generated by the first transformer module 120 or the second power module 130 during operation to the cell module 110. Therefore, the temperature of the surface of the side of the battery cell facing the second transformer module 130 is higher than that of the surface of the side away from the second transformer module 130. If the temperature of the surface of the side of the cell module 110 facing the second transformer module 130 is lower than a safety temperature, the safety of the cell module 110 can be ensured. The temperature detection module 160 may be a thermistor.

In some examples, the maximum output power of the first transformer module 120 is greater than that of the second transformer module 130. Because the first transformer module 120 is farther from the cell module 110 than the second transformer module 130, that the maximum output power of the first transformer module 120 is greater than that of the second transformer module 130 is equivalent to that the larger heat source (the first transformer module 120) is far from the cell module 110 and the smaller heat source (the second transformer module 130) is close to the cell module 110, thereby ensuring the compact structure of the charging control circuit 100 and minimizing the transfer of heat of the first transformer module 120 and the second transformer module 130 to the cell module 110.

With continued reference to FIG. 6, in some examples, the charging control circuit 100 further includes a second control module 170, and the second control module 170 is connected to the first control module 150, the port module 140, and the cell module 110. The second control module 170 is mainly configured to control the charging and discharging of the cell module 110. When the charging control circuit 100 is not connected to the mains supply, the charging control circuit 100 can serve as a portable power source to charge an external load, and the second control module 170 can communicate with the external load based on the charging protocol through the first port 141, the second port 144, and the third port 146. After the handshake is completed, the first control module 150 can adjust output parameters of the cell module 110. On the contrary, an external charger can also charge the cell module 110 through one of the first port 141, the second port 144, and the third port 146.

In some examples, the first transformer module 120 is connected to the cell module 110, or the second transformer module 130 is connected to the cell module 110, or both the first transformer module 120 and the second transformer module 130 are connected to the cell module 110. When the charging control circuit 100 is connected to the mains supply, if the overall output power of the charging control circuit 100 is low and the first transformer module 120 and/or the second transformer module 130 only output a portion of power to the port module 140, the first transformer module 120 and/or the second transformer module 130 can be connected to the cell module 110, so that the first transformer module 120 and/or the second transformer module 130 output the remaining power to charge the cell module 110. If the overall output power of the charging control circuit 100 is high, the first transformer module 120 and/or the second transformer module 130 can be disconnected from the cell module 110, so that the first transformer module 120 and/or the second transformer module 130 preferentially supply power to the external load.

In some examples, the first port 141 includes a first USB-C interface, the second port 144 includes a second USB-C interface, and the third port 146 includes a USB-A interface. The USB-C interface may support a PD protocol, and the USB-A interface may support a quick charge (QC) protocol. Generally, the maximum charging power supported by the PD protocol is higher than that supported by the QC protocol. When the external load is connected to only the first port 141, the first port 141 can obtain the maximum power supply of the charging control circuit 100. When the external load is connected to only the second port 144, the second port 144 can also obtain the maximum power supply of the charging control circuit 100. Therefore, during use, connecting a single external load that supports the USB-C interface does not require deliberately distinguishing which interface the external load is plugged into, but supports blind insertion plugging, thereby improving the convenience of use. Alternatively, external loads can be connected to two USB-C ports for charging. In addition, some external loads can support only the USB-A interface for charging, so one USB-A interface is configured to adapt to more external loads.

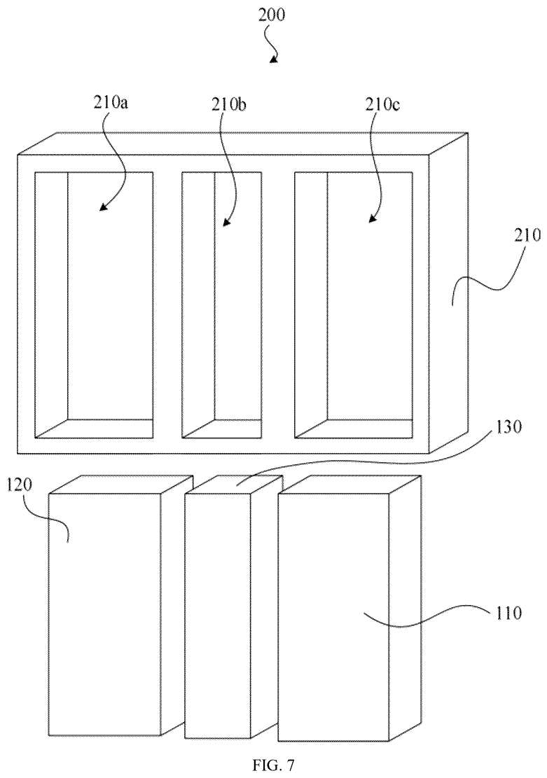

As shown in FIG. 7, a second aspect of the present application provides a charger 200. The charger 200 includes the charging control circuit 100 in any of the above examples and a shell 210.

A first chamber 210a, a second chamber 210b, and a third chamber 210c sequentially adjacent to each other are provided in the shell 210. The first transformer module 120, the second transformer module 130, and the cell module 110 are disposed in the first chamber 210a, the second chamber 210b, and the third chamber 210c, respectively.

The first chamber 210a and the second chamber 210b are separated by an insulating partition to achieve insulation between the first transformer module 120 and the second transformer module 130, and to block some of the heat generated during the operation of the first transformer module 120 from flowing to the second transformer module 130. The second chamber 210b and the third chamber 210c are also separated by an insulating partition to achieve insulation between the second transformer module 130 and the cell module 110, and to block some of the heat generated during the operation of the second transformer module 130 from flowing to the cell module 110. The first control module 150 may be disposed in either the first chamber 210a or the second chamber 210b. The second control module 170 may be disposed in the third chamber 210c.

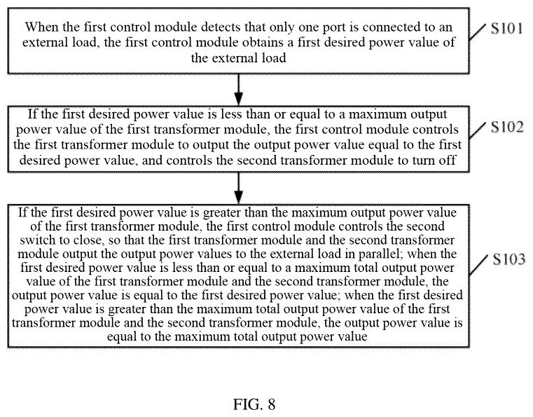

As shown in FIG. 8, a third aspect of the present application provides a charging method. The charging method may include the following steps S101 to S103.

S101. When the first control module 150 detects that only one port is connected to an external load, the first control module 150 obtains a first desired power value of the external load.

S102. If the first desired power value is less than or equal to a maximum output power value of the first transformer module 120, the first control module 150 controls the first transformer module 120 to output the output power value equal to the first desired power value, and controls the second transformer module 130 to turn off.

S103. If the first desired power value is greater than the maximum output power value of the first transformer module 120, the first control module 150 controls the second switch 143 to close, so that the first transformer module 120 and the second transformer module 130 output the output power values to the external load in parallel; when the first desired power value is less than or equal to a maximum total output power value of the first transformer module 120 and the second transformer module 130, the output power value is equal to the first desired power value; when the first desired power value is greater than the maximum total output power value of the first transformer module 120 and the second transformer module 130, the output power value is equal to the maximum total output power value.

Specifically, when the port module 140 includes only the first port 141, or when the port module 140 includes the first port 141 and the second port 144 but only the first port 141 or the second port 144 is connected to the external load, the first power module 120 is preferentially used. When the first power module 120 outputs maximum power, the second power module 130 is then used. Because the first power module 120 is farther from the cell module 110 than the second power module 130, the preferential use of the first power module 120 can minimize heat conduction to the battery cell, thereby protecting the battery cell. The maximum output power of the first power module 120 is 45 W, and the maximum output power of the second power module 130 is 20 W, as an example for explanation below. When the first desired power value of the external load is 45 W, the charger 200 controls the first power module 120 to output 45 W and controls the second transformer module 130 to turn off. When the first desired power value of the external load is 55 W, the charger 200 controls the first power module 120 and the second power module 130 to output power in parallel, where the first power module 120 outputs 45 W and the second power module 130 outputs 10 W. When the first desired power value of the external load is 75 W, the charger 200 controls the first power module 120 and the second power module 130 to output power in parallel, where the first power module 120 outputs 45 W and the second power module 130 outputs 20 W.

In other examples, the charging method may also preferentially use the second power module 130 to power the second port 144, and then use the first power module 120 to power the second port 144. The maximum output power of the first power module 120 is 45 W, and the maximum output power of the second power module 130 is 20 W, as an example for explanation below. When the first desired power value of the external load is 20 W, the charger 200 controls the second power module 130 to output 20 W and controls the first power module 120 to turn off. When the first desired power value of the external load is 45 W, the charger 200 controls the first power module 120 and the second power module 130 to output power in parallel, where the second power module 130 outputs 20 W and the first power module 120 outputs 25 W. When the first desired power value of the external load is 75 W, the charger 200 controls the first power module 120 and the second power module 130 to output power in parallel, where the second power module 130 outputs 20 W and the first power module 120 outputs 45 W.

Notably, because the first power module 120 is farther from the cell module 110 than the second power module 130, the maximum output power of the first power module 120 is usually greater than that of the second power module 130, and the maximum heat generation of the first power module 120 is greater than that of the second power module 130 accordingly. When the temperature of the first power module 120 is high due to heat accumulation during operation at maximum power, the temperature difference between the first power module 120 and the cell module 110 is larger, making it easy to heat up the cell module 110. The first power module 120 is farther from the cell module 110 than the second power module 130, but in the actual manufactured charger 200, due to factors such as the maximum power of the first power module 120, the distance between the first power module 120 and the cell module 110, and the shape of the charger 200, the positive impact of the distance factor on decreasing the temperature of the cell module 110 may be inferior to the negative impact of the excessively high temperature of the first power module 120 on increasing the temperature of the cell module 110.

Therefore, in some examples, the charging method may preferentially use a portion of power of the first power module 120, then use the second power module 130, and finally use all the power of the first power module 120 after the second power module 130 reaches its maximum power. The maximum output power of the first power module 120 is 45 W, and the maximum output power of the second power module 130 is 20 W, as an example for explanation. When the first desired power value of the external load is 25 W, the charger 200 controls the first power module 120 to output 25 W and controls the second power module 130 to turn off. When the first desired power value of the external load is 45 W, the charger 200 controls the first power module 120 and the second power module 130 to output power in parallel, where the first power module 120 outputs 25 W and the second power module 130 outputs 20 W. When the first desired power value of the external load is 55 W, the charger 200 controls the first power module 120 and the second power module 130 to output power in parallel, where the first power module 120 outputs 35 W and the second power module 130 outputs 20 W. When the first desired power value of the external load is 75 W, the charger 200 controls the first power module 120 and the second power module 130 to output power in parallel, where the first power module 120 outputs 45 W and the second power module 130 outputs 20 W.

Based on the above explanation, the positive impact of the distance factor on decreasing the temperature of the cell module 110 may be inferior to the negative impact of the excessively high temperature of the first power module 120 on increasing the temperature of the cell module 110. This possibility also applies to the second power module 130.

The charging method in this example preferentially uses a portion of power of the first power module 120, then uses a portion of power of the second power module 130, uses all the power of the first power module 120, and finally uses all the power of the second power module 130. The maximum output power of the first power module 120 is 45 W, and the maximum output power of the second power module 130 is 20 W, as an example for explanation.

When the first desired power value of the external load is 25 W, the charger 200 controls the first power module 120 to output 25 W and controls the second power module 130 to turn off. When the first desired power value of the external load is 35 W, the charger 200 controls the first power module 120 and the second power module 130 to output power in parallel, where the first power module 120 outputs 25 W and the second power module 130 outputs 10 W. When the first desired power value of the external load is 45 W, the charger 200 controls the first power module 120 and the second power module 130 to output power in parallel, where the first power module 120 outputs 35 W and the second power module 130 outputs 10 W. When the first desired power value of the external load is 60 W, the charger 200 controls the first power module 120 and the second power module 130 to output power in parallel, where the first power module 120 outputs 45 W and the second power module 130 outputs 15 W. When the first desired power value of the external load is 75 W, the charger 200 controls the first power module 120 and the second power module 130 to output power in parallel, where the first power module 120 outputs 45 W and the second power module 130 outputs 20 W.

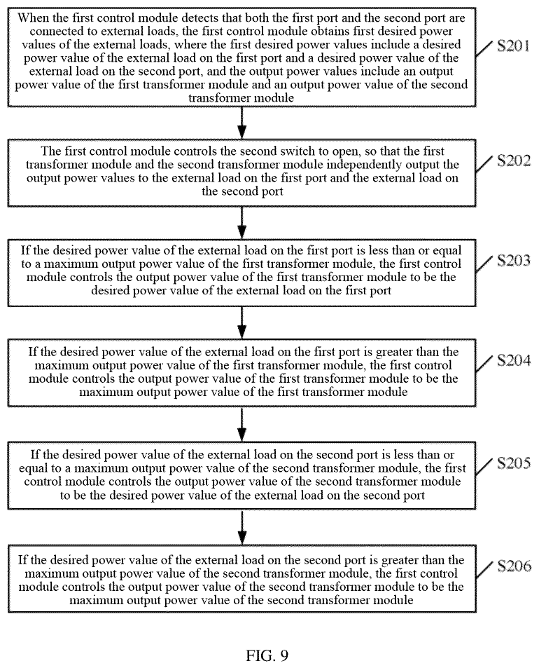

As shown in FIG. 9, a fourth aspect of the present application provides a charging method. The charging method may include the following steps S201 to S206.

S201. When the first control module 150 detects that both the first port 141 and the second port 144 are connected to external loads, the first control module 150 obtains first desired power values of the external loads, where the first desired power values include a desired power value of the external load on the first port 141 and a desired power value of the external load on the second port 144, and the output power values include an output power value of the first transformer module 120 and an output power value of the second transformer module 130.

S202. The first control module 150 controls the second switch 143 to open, so that the first transformer module 120 and the second transformer module 130 independently output the output power values to the external load on the first port 141 and the external load on the second port 144.

S203. If the desired power value of the external load on the first port 141 is less than or equal to a maximum output power value of the first transformer module 120, the first control module 150 controls the output power value of the first transformer module 120 to be the desired power value of the external load on the first port 141.

S204. If the desired power value of the external load on the first port 141 is greater than the maximum output power value of the first transformer module 120, the first control module 150 controls the output power value of the first transformer module 120 to be the maximum output power value of the first transformer module 120.

S205. If the desired power value of the external load on the second port 144 is less than or equal to a maximum output power value of the second transformer module 130, the first control module 150 controls the output power value of the second transformer module 130 to be the desired power value of the external load on the second port 144.

S206. If the desired power value of the external load on the second port 144 is greater than the maximum output power value of the second transformer module 130, the first control module 150 controls the output power value of the second transformer module 130 to be the maximum output power value of the second transformer module 130.

In the charging method of this example, the first power module 120 and the second power module 130 operate independently, the first power module 120 supplies power to the first port 141, and the second power module 130 supplies power to the second port 144. The maximum output power of the first power module 120 is 45 W, and the maximum output power of the second power module 130 is 20 W, as an example for explanation below. When the desired power value of the external load on the first port 141 is 35 W, the charger 200 controls the first power module 120 to output 35 W. When the desired power value of the external load on the first port 141 is 55 W, the charger 200 controls the first power module 120 to output 45 W. When the desired power value of the external load on the second port 144 is 18 W, the charger 200 controls the second power module 130 to output 18 W. When the desired power value of the external load on the second port 144 is 25 W, the charger 200 controls the second power module 130 to output 20 W.

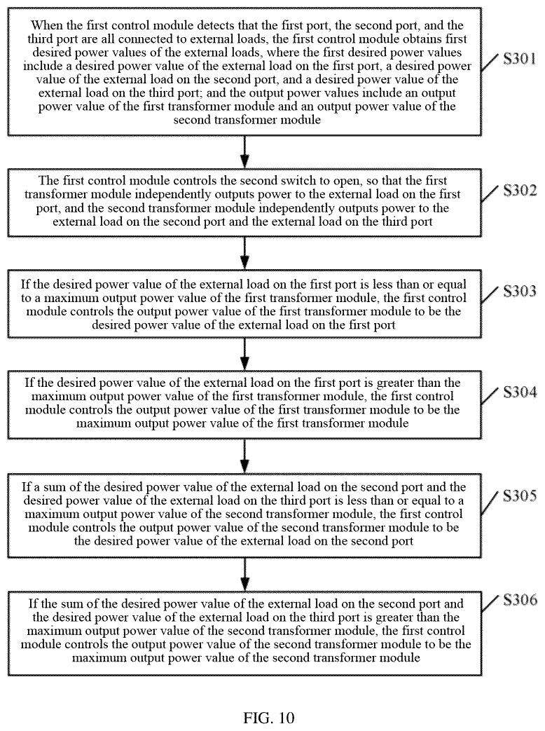

As shown in FIG. 10, a fifth aspect of the present application provides a charging method. The charging method may include the following steps S301 to S306.

S301. When the first control module 150 detects that the first port 141, the second port 144, and the third port 146 are all connected to external loads, the first control module 150 obtains first desired power values of the external loads, where the first desired power values include a desired power value of the external load on the first port 141, a desired power value of the external load on the second port 144, and a desired power value of the external load on the third port 146; and the output power values include an output power value of the first transformer module 120 and an output power value of the second transformer module 130.

S302. The first control module 150 controls the second switch 143 to open, so that the first transformer module 120 independently outputs power to the external load on the first port 141, and the second transformer module 130 independently outputs power to the external load on the second port 144 and the external load on the third port 146.

S303. If the desired power value of the external load on the first port 141 is less than or equal to a maximum output power value of the first transformer module 120, the first control module 150 controls the output power value of the first transformer module 120 to be the desired power value of the external load on the first port 141.

S304. If the desired power value of the external load on the first port 141 is greater than the maximum output power value of the first transformer module 120, the first control module 150 controls the output power value of the first transformer module 120 to be the maximum output power value of the first transformer module 120.

S305. If a sum of the desired power value of the external load on the second port 144 and the desired power value of the external load on the third port 146 is less than or equal to a maximum output power value of the second transformer module 130, the first control module 150 controls the output power value of the second transformer module 130 to be the desired power value of the external load on the second port 144.

S306. If the sum of the desired power value of the external load on the second port 144 and the desired power value of the external load on the third port 146 is greater than the maximum output power value of the second transformer module 130, the first control module 150 controls the output power value of the second transformer module 130 to be the maximum output power value of the second transformer module 130.

Specifically, in the charging method of this example, the first power module 120 and the second power module 130 operate independently, the first power module 120 supplies power to the first port 141, and the second power module 130 supplies power to the second port 144 and the third port 146. The maximum output power of the first power module 120 is 45 W, and the maximum output power of the second power module 130 is 20 W, as an example for explanation below. When the desired power value of the external load on the first port 141 is 35 W, the charger 200 controls the first power module 120 to output 35 W. When the desired power value of the external load on the first port 141 is 55 W, the charger 200 controls the first power module 120 to output 45 W. When the sum of the desired power value of the external load on the second port 144 and the desired power value of the external load on the third port 146 is 18 W, the charger 200 controls the second power module 130 to output 18 W. When the sum of the desired power value of the external load on the second port 144 and the desired power value of the external load on the third port 146 is 25 W, the charger 200 controls the second power module 130 to output 20 W.

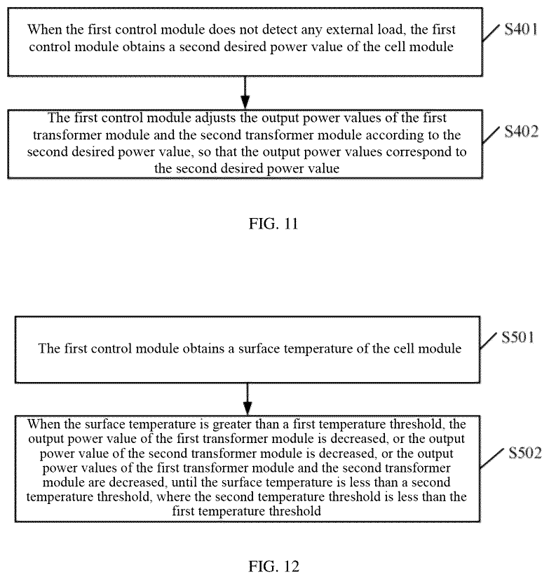

In some examples, as shown in FIG. 11, the charging method further includes the following steps S401 and S402.

S401. When the first control module 150 does not detect any external load, the first control module 150 obtains a second desired power value of the cell module.

S402. The first control module 150 adjusts the output power values of the first transformer module 120 and the second transformer module 130 according to the second desired power value, so that the output power values correspond to the second desired power value.

Specifically, according to the different second desired power value, the charger 200 can adjust the charging mode of the cell module 110, that is, the first transformer module 120 charges the cell module 110 alone, or the second transformer module 130 charges the cell module 110 alone, or the first transformer module 120 and the second transformer module 130 jointly charge the cell module 110.

The maximum output power of the first power module 120 is 45 W, and the maximum output power of the second power module 130 is 20 W, as an example for explanation below. When the second desired power value of the cell module 110 is 45 W, the charger 200 controls the first power module 120 to output 45 W and controls the second power module 130 to turn off. When the second desired power value of the cell module 110 is 55 W, the charger 200 controls the first power module 120 and the second power module 130 to output power in parallel, where the first power module 120 outputs 45 W and the second power module 130 outputs 10 W. When the second desired power value of the cell module 110 is 75 W, the charger 200 controls the first power module 120 and the second power module 130 to output power in parallel, where the first power module 120 outputs 45 W and the second power module 130 outputs 20 W.

In some examples, as shown in FIG. 12, the charging method further includes the following steps S501 and S502.

S501. The first control module 150 obtains a surface temperature of the cell module 110.

S502. When the surface temperature is greater than a first temperature threshold, the output power value of the first transformer module 120 is decreased, or the output power value of the second transformer module 130 is decreased, or the output power values of the first transformer module 120 and the second transformer module 130 are decreased, until the surface temperature is less than a second temperature threshold, where the second temperature threshold is less than the first temperature threshold.

Specifically, when the positive impact of the distance factor on decreasing the temperature of the cell module 110 is less than the negative impact of the excessively high temperature of the first power module 120 on increasing the temperature of the cell module 110, a portion of the power of the first power module 120 is preferentially decreased, then the second power module 130 is completely turned off, and finally the first power module 120 is completely turned off.

The maximum output power of the first power module 120 is 45 W, the maximum output power of the second power module 130 is 20 W, and the first temperature threshold is 58° C. as an example for explanation below. When the temperature of the cell module 110 is more than 58° C., if the first power module 120 outputs 45 W and the second power module 130 outputs 20 W, the charger 200 controls the first power module 120 to output 25 W. If the first power module 120 outputs 25 W and the second power module 130 outputs 20 W, the charger 200 controls the second power module 130 to turn off. If the first power module 120 outputs 25 W and the second power module 130 is turned off, the charger 200 controls the first power module 120 to turn off.

When the positive impact of the distance factor on decreasing the temperature of the cell module 110 is greater than the negative impact of the excessively high temperature of the first power module 120 on increasing the temperature of the cell module 110, a portion of the power of the second power module 130 is preferentially decreased, then a portion of the power of the first power module 120 is decreased, the second power module 130 is completely turned off, and finally the first power module 120 is completely turned off.

The maximum output power of the first power module 120 is 45 W, the maximum output power of the second power module 130 is 20 W, and the first temperature threshold is 58° C. as an example for explanation below. When the temperature of the cell module 110 is more than 58° C., if the first power module 120 outputs 45 W and the second power module 130 outputs 20 W, the charger 200 controls the second power module 130 to output 10 W. If the first power module 120 outputs 45 W and the second power module 130 outputs 10 W, the charger 200 controls the first power module 120 to output 25 W. If the first power module 120 outputs 25 W and the second power module 130 outputs 10 W, the charger 200 controls the second power module 130 to turn off. If the first power module 120 outputs 25 W and the second power module 130 is turned off, the charger 200 controls the first power module 120 to turn off.

Notably, when the temperature of the cell module 110 exceeds a third temperature threshold, in order to protect the cell module 110, regardless of the working state of the first power module 120 and the second power module 130, the charger 200 immediately turns off the first power module 120 and the second power module 130.

The same or similar reference numerals in the accompanying drawings of the examples correspond to the same or similar components. In the description of the present application, it should be understood that if the terms such as “up”, “down”, “left”, and “right” indicate orientations or positional relationships based on the orientations or positional relationships shown in the accompanying drawings, the terms are only for the convenience of describing the present application and simplifying the description, and do not indicate or imply that an apparatus or component referred to must have a specific orientation or be constructed and operated in a specific orientation. Therefore, the terms for describing the positional relationships in the accompanying drawings are only for illustrative description and cannot be understood as limitations of this patent. Those of ordinary skill in the art can understand the specific meanings of the above terms according to specific situations.

Described above are merely the examples of the present application, which are not used for limiting the present application. Any modification, equivalent replacement and improvement, and the like made within the spirit and principle of the present application shall fall within the protection scope of the present application.

What is claimed is:

1. A charging control circuit, comprising:
a battery;
a first transformer circuit;
a second transformer circuit disposed between the first transformer circuit and the battery;
a port circuit connected to an output terminal of the first transformer circuit, an output terminal of the second transformer circuit, and the battery, respectively; and
a controller connected to the first transformer circuit, the second transformer circuit, and the port circuit, respectively, wherein the controller is configured to adjust output power values of the first transformer circuit and the second transformer circuit according to a power value of an external load.

2. The charging control circuit according to claim 1, wherein the port circuit comprises:
a first port connected to the output terminal of the first transformer circuit and the controller;
a first switch connected in series between the output terminal of the first transformer circuit and the first port, and connected to the controller, wherein the first switch is configured to connect or disconnect the first port and the first transformer circuit; and
a second switch connected between the output terminal of the first transformer circuit and the output terminal of the second transformer circuit, and connected to the controller, wherein the second switch is configured to enable parallel output or independent output of the first transformer circuit and the second transformer circuit.

3. The charging control circuit according to claim 2, wherein the port circuit further comprises:
a second port connected to the output terminal of the second transformer circuit and the controller; and
a third switch connected in series between the output terminal of the second transformer circuit and the second port, and connected to the controller, wherein the third switch is configured to connect or disconnect the second port and the second transformer circuit.

4. The charging control circuit according to claim 3, wherein the port circuit further comprises:
a third port connected to the output terminal of the second transformer circuit and the controller; and
a fourth switch connected in series between the output terminal of the second transformer circuit and the third port, wherein the fourth switch is configured to connect or disconnect the third port and the second transformer circuit.

5. The charging control circuit according to claim 1, further comprising a thermistor, wherein the thermistor is disposed on a surface of a side of the battery facing the second transformer circuit, and wherein the thermistor is connected to the controller.

6. The charging control circuit according to claim 1, wherein a maximum output power of the first transformer circuit is greater than that of the second transformer circuit.

7. The charging control circuit according to claim 1, further comprising a second controller, wherein the second controller is connected to the controller, the port circuit, and the battery.

8. The charging control circuit according to claim 1, wherein the first transformer circuit is connected to the battery, or the second transformer circuit is connected to the battery, or both the first transformer circuit and the second transformer circuit are connected to the battery.

9. The charging control circuit according to claim 2, wherein based on the controller detecting that one port is connected to an external load, the controller obtains the power value of the external load;
based on the power value being less than or equal to a maximum output power value of the first transformer circuit, the controller controls the first transformer circuit to output an output power value equal to the power value, and controls the second transformer circuit to turn off; and
based on the power value being greater than the maximum output power value of the first transformer circuit, the controller controls the second switch to close, so that the first transformer circuit and the second transformer circuit output the output power values to the external load in parallel.

10. The charging control circuit according to claim 3, wherein based on the controller detecting that both the first port and the second port are connected to external loads, the controller is configured to obtain power values of the external loads, wherein the power values comprise a power value of an external load on the first port and a power value of an external load on the second port, and the output power values comprise an output power value of the first transformer circuit and an output power value of the second transformer circuit;
the controller controls the second switch to open, so that the first transformer circuit and the second transformer circuit independently output the output power values to the external load on the first port and the external load on the second port;
based on the power value of the external load on the first port being less than or equal to a maximum output power value of the first transformer circuit, the controller controls the output power value of the first transformer circuit to be the power value of the external load on the first port;
based on the power value of the external load on the first port being greater than the maximum output power value of the first transformer circuit, the controller controls the output power value of the first transformer circuit to be the maximum output power value of the first transformer circuit;
based on the power value of the external load on the second port being less than or equal to a maximum output power value of the second transformer circuit, the controller controls the output power value of the second transformer circuit to be the power value of the external load on the second port; and
based on the power value of the external load on the second port being greater than the maximum output power value of the second transformer circuit, the controller controls the output power value of the second transformer circuit to be the maximum output power value of the second transformer circuit.

11. The charging control circuit according to claim 4, wherein based on the controller detecting that the first port, the second port, and the third port are all connected to external loads, the controller is configured to obtain power values of the external loads, wherein the power values comprise a power value of an external load on the first port, a power value of an external load on the second port, and a power value of an external load on the third port; and
the output power values comprise an output power value of the first transformer circuit and an output power value of the second transformer circuit;
the controller controls the second switch to open, so that the first transformer circuit independently outputs power to the external load on the first port, and the second transformer circuit independently outputs power to the external load on the second port and the external load on the third port;
based on the power value of the external load on the first port being less than or equal to a maximum output power value of the first transformer circuit, the controller controls the output power value of the first transformer circuit to be the power value of the external load on the first port;
based on the power value of the external load on the first port being greater than the maximum output power value of the first transformer circuit, the controller controls the output power value of the first transformer circuit to be the maximum output power value of the first transformer circuit;
based on a sum of the power value of the external load on the second port and the power value of the external load on the third port being less than or equal to a maximum output power value of the second transformer circuit, the controller controls the output power value of the second transformer circuit to be the power value of the external load on the second port; and
based on the sum of the power value of the external load on the second port and the power value of the external load on the third port being greater than the maximum output power value of the second transformer circuit, the controller controls the output power value of the second transformer circuit to be the maximum output power value of the second transformer circuit.

12. A charger, comprising a shell and a charging control circuit, wherein the charging control circuit comprises:
a battery;
a first transformer circuit;
a second transformer circuit disposed between the first transformer circuit and the battery;
a port circuit connected to an output terminal of the first transformer circuit, an output terminal of the second transformer circuit, and the battery, respectively; and
a controller connected to the first transformer circuit, the second transformer circuit, and the port circuit, respectively, wherein the controller is configured to adjust output power values of the first transformer circuit and the second transformer circuit according to a power value of an external load;
wherein the shell has a first chamber, a second chamber, and a third chamber sequentially adjacent to each other, and wherein the first transformer circuit, the second transformer circuit, and the battery are sequentially disposed in the first chamber, the second chamber, and the third chamber.

13. The charger according to claim 12, wherein the charging control circuit further comprises a thermistor, wherein the thermistor is disposed on a surface of a side of the battery facing the second transformer circuit, and wherein the thermistor is connected to the controller.

14. The charger according to claim 12, wherein a maximum output power of the first transformer circuit is greater than that of the second transformer circuit.

15. The charger according to claim 12, wherein the charging control circuit further comprises a second controller, and wherein the second controller is connected to the controller, the port circuit, and the battery.

16. A charging method comprising:
obtaining, by a controller and based on detecting that one port is connected to an external load, a power value of the external load;
controlling, based on the power value being less than or equal to a maximum output power value of a first transformer circuit, the first transformer circuit to output an output power value equal to the power value, and controlling a second transformer circuit to turn off; and
controlling, based on the power value being greater than the maximum output power value of the first transformer circuit, a second switch to close, so that the first transformer circuit and the second transformer circuit output output power values to the external load in parallel;
wherein based on the power value being less than or equal to a maximum total output power value of the first transformer circuit and the second transformer circuit, a sum of the output power values is equal to the power value; wherein based on the power value being greater than the maximum total output power value of the first transformer circuit and the second transformer circuit, the sum of the output power values is equal to the maximum total output power value,
wherein the second transformer circuit disposed between the first transformer circuit and a battery; a port circuit connected to an output terminal of the first transformer circuit, an output terminal of the second transformer circuit, and the battery, respectively; and the controller connected to the first transformer circuit, the second transformer circuit, and the port circuit, respectively,
and wherein the port circuit comprises a first port connected to the output terminal of the first transformer circuit and the controller; a first switch connected in series between the output terminal of the first transformer circuit and the first port, and connected to the controller; and
the second switch connected between the output terminal of the first transformer circuit and the output terminal of the second transformer circuit, and connected to the controller.

17. The charging method according to claim 16, further comprising:
obtaining, based on not detecting an external load, a second power value of the battery; and
adjusting the output power values of the first transformer circuit and the second transformer circuit according to the second power value.

18. The charging method according to claim 16, further comprising:
obtaining a surface temperature of the battery; and
wherein based on the surface temperature being greater than a first temperature threshold, an output power value of the first transformer circuit is decreased, or an output power value of the second transformer circuit is decreased, or the output power values of the first transformer circuit and the second transformer circuit are decreased, until the surface temperature is less than a second temperature threshold, and wherein the second temperature threshold is less than the first temperature threshold.

19. The charging method according to claim 16 further comprising:
obtaining, based on detecting that both the first port and a second port are connected to external loads, power values of the external loads, wherein the power values comprise a power value of an external load on the first port and a power value of an external load on the second port, and the output power values comprise an output power value of the first transformer circuit and an output power value of the second transformer circuit;
controlling the second switch to open, so that the first transformer circuit and the second transformer circuit independently output the output power values to the external load on the first port and the external load on the second port;
controlling, based on the power value of the external load on the first port being less than or equal to the maximum output power value of the first transformer circuit, the output power value of the first transformer circuit to be the power value of the external load on the first port;
controlling, based on the power value of the external load on the first port being greater than the maximum output power value of the first transformer circuit, the output power value of the first transformer circuit to be the maximum output power value of the first transformer circuit;
controlling, based on the power value of the external load on the second port being less than or equal to a maximum output power value of the second transformer circuit, the output power value of the second transformer circuit to be the power value of the external load on the second port; and
controlling, based on the power value of the external load on the second port being greater than the maximum output power value of the second transformer circuit, the output power value of the second transformer circuit to be the maximum output power value of the second transformer circuit,
wherein the port circuit further comprises the second port connected to the output terminal of the second transformer circuit and the controller; and a third switch connected in series between the output terminal of the second transformer circuit and the second port, and connected to the controller.

20. The charging method according to claim 19 further comprising:
obtaining, based on detecting that the first port, the second port, and a third port are all connected to second external loads, second power values of the second external loads, wherein the second power values comprise a second power value of the external load on the first port, a second power value of the external load on the second port, and a power value of an external load on the third port;
controlling the second switch to open, so that the first transformer circuit independently outputs power to the external load on the first port, and the second transformer circuit independently outputs power to the external load on the second port and the external load on the third port;
controlling, based on the second power value of the external load on the first port being less than or equal to the maximum output power value of the first transformer circuit, the output power value of the first transformer circuit to be the second power value of the external load on the first port;
controlling, based on the second power value of the external load on the first port being greater than the maximum output power value of the first transformer circuit, the output power value of the first transformer circuit to be the maximum output power value of the first transformer circuit;
controlling, based on a sum of the second power value of the external load on the second port and the power value of the external load on the third port being less than or equal to the maximum output power value of the second transformer circuit, the output power value of the second transformer circuit to be the second power value of the external load on the second port; and
controlling, based on the sum of the second power value of the external load on the second port and the power value of the external load on the third port being greater than the maximum output power value of the second transformer circuit, the output power value of the second transformer circuit to be the maximum output power value of the second transformer circuit,
wherein the port circuit further comprises the third port connected to the output terminal of the second transformer circuit and the controller, and a fourth switch connected in series between the output terminal of the second transformer circuit and the third port.
